(19) United States
(12) Patent Application Publication
(10) Pub. No.: US 2008/0306614 A1
(43) Pub. Date: Dec. 11, 2008

(54) Four sensor control

(76) Inventor: James W. Burrell, IV, Union, NJ (US)

Correspondence Address: THOMAS MICHAEL BEHUNIN, 2170 EAST 660 NORTH CIRCLE, SAINT GEORGE, UT, 84790, US

(21) Appl. No.: 11/811,226

(22) Filed: Jun. 7, 2007

(51) Int. Cl. G05B 11/01

(52) U.S. Cl. 700/12

(57) ABSTRACT

Combinations of four sensors control an object, enabling movement for robots, toys, video games, etc. Activating four sensors independently controls an object in four different directions. Multiple methods of using only four sensors to control the state of an object in a two dimensional environment or a three dimensional environment. Methods of using only four sensors to increase or decrease control of an object. Methods of using only four sensors to control the state of an object. Activating four sensors individually, simultaneously or sequentially controls an object in multiple states. Activating at least one sensor followed by or combined with the activation of at least one sensor controls an object in multiple directions. Simultaneously and sequentially activating combinations of four sensors controls an object in more than four different directions. A method of using four sensors to control cursor movement in four directions. Simultaneous activation of the left and right cursor keys exits a cursor movement mode and enters a first editing mode, wherein the left cursor key backspaces and the right cursor key deletes data, and simultaneous activation of the left and right cursor keys exits the first editing mode and re-enters the cursor movement mode or another mode. Simultaneous activation of the up and down cursor keys exits a cursor movement mode and enters a second editing mode, wherein the up cursor key reverses the last undo and the down cursor key reverses the last change, and simultaneous activation of the up and down cursor keys exits the second editing mode and re-enters the cursor movement mode or another mode. Activation of a fifth sensor exits a first or second editing mode and re-enters a cursor movement mode.

### RELATED APPLICATION

This application is an improvement of U.S. Pat. No. 7,160,042 B2, filed Sep. 11, 2002 and issued Jan. 9, 2007.

### FIELD OF THE INVENTION

This invention relates to a methods of control using only four sensors to control the state of an object in multiple modes or in multiple directions (up, down, left, right, forward, backward, and combinations thereof.

### BACKGROUND OF THE INVENTION

Computers, robots, toys, video games, etc. require two dimensional and three dimensional movement and other types of control means. Keyboards, pointing devices, game controllers, mice, trackballs, joysticks, isopoints, touchpads, touchscreens and a variety of other types of devices have all been used in the past. A compact and faster means of control is needed. Despite the simplification of control devices, it is still difficult for a user with little or no computer or gaming experience to navigate through an application program.

### DESCRIPTION OF PRIOR ART

There are numerous well-known, prior art methods of movement using four sensors independently, the best example would be the cursor control keys on a computer keyboard. With the rapid development of man-machine interfaces for communicating and control, improved control means and methods of movement are becoming increasingly necessary. There is a significant need for a system and method allowing easy navigation through an application program without the need for extensive computer operating or gaming experience. The main objective of the present invention is to overcome all the deficiencies found in all prior art devices using only four sensors for movement and control. Further objects and advantages will become apparent from a consideration of the ensuing description.

### SUMMARY OF THE INVENTION

Preferred embodiments of the present invention use only four binary sensors or four variable controlled sensors to control the state of an object. Briefly described, in one of the preferred embodiments of the present invention, combinations of four sensors control an object, enabling movement of robots, toys, video games, etc.

Activating the cursor left key moves left.

Activating the cursor right key moves right.

Activating the cursor up key moves forward.

Activating the cursor up key followed by the cursor left key moves forward and leftward, and deactivating the cursor left key continues forward movement.

Activating the cursor up key followed by the cursor right key moves forward and rightward, and deactivating the cursor right key continues forward movement.

Activating the cursor down key moves backward.

Activating the cursor down key followed by the cursor left key moves backward and leftward, and deactivating the cursor left key continues backward movement.

Activating the cursor down key followed by the cursor right key moves backward and rightward, and deactivating the cursor right key continues backward movement.

Activating the cursor up key followed by the cursor down key accelerates forward, and deactivating the cursor down key continues forward movement.

Activating the cursor up key followed by the cursor down key accelerates forward, followed by the cursor left key accelerates forward and leftward, and deactivating the cursor left key continues forward acceleration.

Activating the cursor up key followed by the cursor down key accelerates forward, followed by the cursor right key accelerates forward and rightward, and deactivating the cursor right key continues forward acceleration.

Activating the cursor up key followed by the cursor left key and the cursor right key accelerates forward and upward (jump or climb), followed by deactivating the cursor left key and the cursor right key continues forward movement.

Activating the cursor up key followed by the cursor left key, the cursor down key and the cursor right key accelerates forward and downward (dive), followed by deactivating the cursor left key, the cursor down key and the cursor right key continues forward movement.

Simultaneously activating then deactivating the cursor left key and the cursor right key reduces an object's position (crouching down), followed by simultaneously activating then deactivating the cursor left key and the cursor right key returns an object to its original position (standing).

Simultaneously activating then deactivating the cursor left key and the cursor right key reduces an object's position (crouching down), followed by activating the cursor left key moves leftward in a reduced position (crouching down and moving leftward).

Simultaneously activating then deactivating the cursor left key and the cursor right key reduces an object's position (crouching down), followed by activating the cursor right key moves rightward in a reduced position (crouching down and moving rightward).

Simultaneously activating then deactivating the cursor left key and the cursor right key reduces an object's position (crouching down), followed by activating the cursor up key moves forward in a reduced position (crouching down and moving forward).

Simultaneously activating then deactivating the cursor left key and the cursor right key reduces an object's position (crouching down), followed by activating the cursor up key followed by the cursor left key moves forward and leftward in a reduced position (crouching down and moving forward and leftward).

Simultaneously activating then deactivating the cursor left key and the cursor right key reduces an object's position (crouching down), followed by activating the cursor up key followed by the right key moves forward and rightward in a reduced position (crouching down and moving forward and rightward).

Simultaneously activating then deactivating the cursor left key and the cursor right key reduces an object's position (crouching down), followed by activating the cursor down key moves backward in a reduced position (crouching down and moving backward).

Simultaneously activating then deactivating the cursor left key and the cursor right key reduces an object's position (crouching down), followed by activating the cursor down key followed by the cursor left key moves backward and leftward in a reduced position (crouching down and moving backward and leftward).

Simultaneously activating then deactivating the cursor left key and the cursor right key reduces an object's position (crouching down), followed by activating the cursor down key followed by the right key moves backward and rightward in a reduced position (crouching down and moving backward and rightward).

Simultaneously activating then deactivating the cursor left key, the cursor down key and the cursor right key reduces an object to its lowest position (lying down), followed by simultaneously activating then deactivating the cursor left key, the cursor down key and the cursor right key returns an object to its original position (standing).

Simultaneously activating then deactivating the cursor left key, the cursor down key and the cursor right key reduces an object to its lowest position (lying down), followed by activating the cursor left key moves leftward in a prone position (crawling leftward).

Simultaneously activating then deactivating the cursor left key, the cursor down key and the cursor right key reduces an object to its lowest position (lying down), followed by activating the cursor right key moves rightward in a prone position (crawling rightward).

Simultaneously activating then deactivating the cursor left key, the cursor down key and the cursor right key reduces an object to its lowest position (lying down), followed by activating the cursor up key moves forward in a prone position (crawling forward).

Simultaneously activating then deactivating the cursor left key, the cursor down key and the cursor right key reduces an object to its lowest position (lying down), followed by activating the cursor up key followed by the cursor left key moves forward and leftward in a prone position (crawling forward and leftward).

Simultaneously activating then deactivating the cursor left key, the cursor down key and the cursor right key reduces an object to its lowest position (lying down), followed by activating the cursor up key followed by the cursor right key moves forward and rightward in a prone position (crawling forward and rightward).

Simultaneously activating then deactivating the cursor left key, the cursor down key and the cursor right key reduces an object to its lowest position (lying down), followed by activating the cursor down key moves backward in a prone position (crawling backward).

Simultaneously activating then deactivating the cursor left key, the cursor down key and the cursor right key reduces an object to its lowest position (lying down), followed by activating the cursor down key followed by the cursor left key moves backward and leftward in a prone position (crawling backward and leftward).

Simultaneously activating then deactivating the cursor left key, the cursor down key and the cursor right key reduces an object to its lowest position (lying down), followed by activating the cursor down key followed by the cursor right key moves backward and rightward in a prone position (crawling backward and rightward).

Simultaneously activating the cursor left key, the cursor up key and the cursor down key rotates counterclockwise. Simultaneously activating the cursor right key, the cursor up key and the cursor down key rotates clockwise.

Simultaneously activating the cursor up key and the cursor left key climbs and rolls left. Simultaneously activating the cursor up key and the cursor right key climbs and rolls right.

Simultaneously activating the cursor down key and the cursor left key dives and rolls left. Simultaneously activating the cursor down key and the cursor right key dives and rolls right.

Simultaneously activating then deactivating the cursor left key and the cursor right key changes action modes. Simultaneously activating then deactivating the cursor left key, the cursor down key and the cursor right key changes action modes. Simultaneously activating then deactivating the cursor up key and the cursor down key changes action modes.

Another preferred embodiment of the present invention allows multiple methods of control using only four sensors. Activating a left sensor moves an object to the left and deactivating the left sensor stops leftward movement. Activating a right sensor moves an object to the right and deactivating the right sensor stops rightward movement. Simultaneously activating the left and right sensor exits a cursor movement mode and enters an editing mode. Activating the left sensor backspaces and deactivating the left sensor stops backspacing. Activating the right sensor deletes data and deactivating the right sensor stops deleting data. Simultaneously activating the left and right sensor or activating a fifth sensor exits the editing mode and re-enters the cursor movement mode.

Activating an up sensor moves an object upward and deactivating the up sensor stops upward movement. Activating a down sensor moves an object downward and deactivating the down sensor stops downward movement. Simultaneously activating the up and down sensor exits a cursor movement mode and enters an editing mode. Activating the up sensor reverses the last undo and deactivating the up sensor stops the reversing of the last undo. Activating the down sensor reverses the last change and deactivating the down sensor stops the reversing of the last change. Simultaneously activating the up and down sensor or activating a fifth sensor exits the editing mode and re-enters the cursor movement mode.

The system and method of the four sensor control invention, according to the preferred embodiment and alternative preferred embodiments of the invention, are logically developed, relatively easy to learn and very quick to use.

These and other features of the present invention will be more fully understood by reference to the following drawings and the detailed description of the preferred embodiment.

### DESCRIPTION OF THE DRAWINGS

FIG. 1. Illustrates one preferred numbered arrangement of a four sensor embodiment found in the disclosed invention.

FIG. 2. Illustrates one preferred arrangement of a four sensor embodiment found in the disclosed invention using preferred arrows for direction.

FIG. 3. Illustrates one preferred numbered arrangement of a four sensor embodiment found in the disclosed invention.

FIG. 4. Illustrates one preferred arrangement of a four sensor embodiment found in the disclosed invention using preferred arrows for direction.

FIG. 5. Illustrates one preferred numbered arrangement of a four sensor embodiment found in the disclosed invention.

FIG. 6. Illustrates one preferred arrangement of a four sensor embodiment found in the disclosed invention using preferred arrows for direction.

FIG. 7. Illustrates one preferred numbered arrangement of a four sensor embodiment found in the disclosed invention.

FIG. 8. Illustrates one preferred arrangement of a four sensor embodiment found in the disclosed invention using preferred arrows for direction.

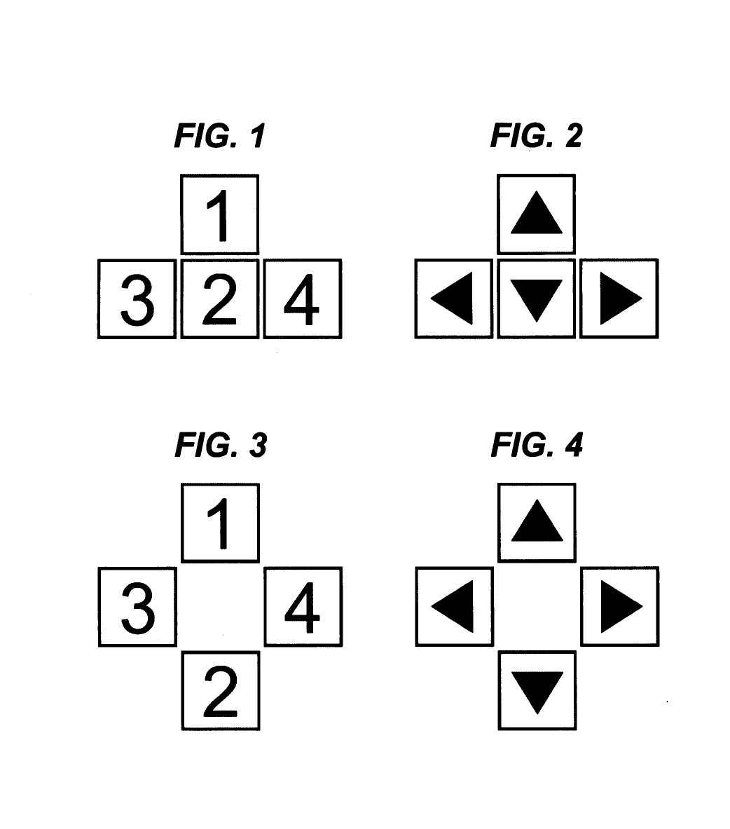

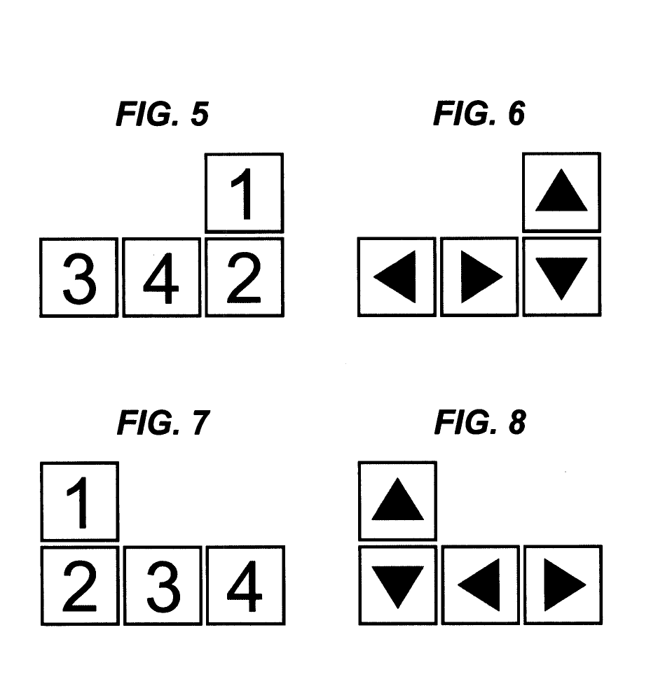

### DETAILED DESCRIPTION OF THE PREFERRED EMBODIMENT

In order to more fully understand the invention, during the course of this description the four sensor control invention and embodiments will be labeled and explained as a first sensor, a second sensor, a third sensor and a fourth sensor, and will be used to easily identify like elements according to the different figures which illustrate the invention. The preferred embodiment of the disclosed invention is shown in FIGS. 2, 4, 6 and 8 in the preferred embodiment's simplest binary sensor on/off method form.

Preferred embodiments of the present invention use only four binary sensors or four variable controlled sensors to control the state of an object.

In one preferred embodiment of the present invention, combinations of four sensors control an object, enabling movement for robots, toys, video games, etc. Activating four sensors individually controls an object in four states of control. Simultaneously activating combinations of four sensors controls an object in more than four states of control. Activating one sensor individually followed by activating combinations of four sensors controls an object in more than four states of control.

In another preferred embodiment, combinations of four sensors control an object, enabling movement for robots, toys, video games, etc. Activating four sensors individually to move an object in four different directions. Simultaneously activating combinations of four sensors moves an object in more than four different directions. Activating one sensor individually followed by activating combinations of four sensors moves an object in more than four different directions.

In another preferred embodiment, combinations of four sensors control an object, enabling movement for robots, toys, video games, etc. Activating a first sensor, preferably an up sensor, controls an object in a first state, preferably moving forward. Deactivating a first sensor stops control of an object in a first state. Activating a second sensor, preferably a down sensor, controls an object in a second state, preferably moving backward. Deactivating a second sensor stops control of an object in a second state. Activating a third sensor, preferably a left sensor, controls an object in a third state, preferably moving leftward. Deactivating a third sensor stops control of an object in a third state. Activating a fourth sensor, preferably a right sensor, controls an object in a fourth state, preferably moving rightward. Deactivating a fourth sensor stops control of an object in a fourth state.

Activating a first sensor controls an object in a first state. Simultaneously activating a third sensor with an activated first sensor controls an object in a fifth state, preferably moving forward and rightward. Deactivating a third sensor continues control of an object in a first state. Deactivating a first sensor stops control of an object in a first state. Activating a first sensor controls an object in a first state. Simultaneously activating a fourth sensor with an activated first sensor controls an object in a sixth state, preferably moving forward and rightward. Deactivating a fourth sensor continues control of an object in a first state. Deactivating a first sensor stops control of an object in a first state.

Activating a second sensor controls an object in a second state. Simultaneously activating a third sensor with an activated second sensor controls an object in a seventh state, preferably backward and leftward. Deactivating a third sensor continues control of an object in a second state. Deactivating a second sensor stops control of an object in a second state. Activating a second sensor controls an object in a second state. Simultaneously activating a fourth sensor with an activated second sensor controls an object in an eighth state, preferably backward and rightward. Deactivating a fourth sensor continues control of an object in a second state. Deactivating a second sensor stops control of an object in a second state.

In another preferred embodiment, combinations of four sensors control an object, enabling movement for robots, toys, video games, etc. Activating a first sensor, preferably an up sensor, controls an object in a first state, preferably moving forward. Simultaneously activating a second sensor, preferably a down sensor, with an activated first sensor controls an object in a ninth state, preferably accelerating forward. Deactivating a second sensor stops a control of an object in a ninth state and continue control of an object in a first state. Deactivating a first sensor stops control of an object in a first state.

In another preferred embodiment, combinations of four sensors control an object, enabling movement for robots, toys, video games, etc. Activating a first sensor, preferably an up sensor, controls an object in a first state, preferably moving forward. Simultaneously activating a second sensor, preferably a down sensor, with an activated first sensor controls an object in a ninth state, preferably accelerating forward. Simultaneously activating a third sensor, preferably a left sensor, with an activated first sensor and an activated second sensor controls an object in a tenth state, preferably accelerating forward and leftward. Deactivating a third sensor stops a control of an object in a tenth state and continue a control of an object in a ninth state. Simultaneously activating a fourth sensor, preferably a right sensor, with an activated first sensor and an activated second sensor controls an object in an eleventh state, preferably accelerating forward and rightward. Deactivating a fourth sensor stops a control of an object in a eleventh state and continue a control of an object in a ninth state. Deactivating a second sensor stops a control of an object in a ninth state and continue a control of an object in a first state. Deactivating a first sensor stops control of an object in a first state.

In another preferred embodiment, combinations of four sensors control an object, enabling movement for robots, toys, video games, etc. Activating a first sensor, preferably an up sensor, controls an object in a first state, preferably moving forward. Simultaneously activating a third sensor, preferably a left sensor, and a fourth sensor, preferably a right sensor, with an activated first sensor controls an object in a twelfth state, preferably accelerating forward and upward. Simultaneously deactivating a third sensor and a fourth sensor continues control of an object in a first state. Deactivating a first sensor stops control of an object in a first state.

In another preferred embodiment, combinations of four sensors control an object, enabling movement for robots, toys, video games, etc. Activating a first sensor, preferably an up sensor, controls an object in a first state, preferably moving forward. Simultaneously activating a third sensor, preferably a left sensor, a second sensor, preferably a down sensor, and a fourth sensor, preferably a right sensor, with an activated first sensor controls an object in a thirteenth state, preferably accelerating forward and downward. Simultaneously deactivating a third sensor, a second sensor and a fourth sensor continues control of an object in a first state. Deactivating a first sensor stops control of an object in a first state.

In another preferred embodiment, combinations of four sensors control an object, enabling movement for robots, toys, video games, etc. Simultaneously activating and deactivating a third sensor, preferably a left sensor, and a fourth sensor, preferably a right sensor, controls an object in a fourteenth state, preferably reducing an object's position. Simultaneously activating and deactivating a third sensor and a fourth sensor exits control of an object in a fourteenth state.

In another preferred embodiment, combinations of four sensors control an object, enabling movement for robots, toys, video games, etc. Simultaneously activating and deactivating a third sensor, preferably a left sensor, and a fourth sensor, preferably a right sensor, controls an object in a fourteenth state, preferably reducing an object's position. Activating a third sensor controls an object in a fifteenth state, preferably reducing an object's position and moving leftward. Activating a fourth sensor controls an object in a sixteenth state, preferably reducing an object's position and moving rightward. Activating a first sensor, preferably an up sensor, controls an object in a seventeenth state, preferably reducing an object's position and moving forward. Simultaneously activating a third sensor with an activated first sensor controls an object in an eighteenth state. Deactivating a third sensor continues control of an object in a seventeenth state, preferably reducing an object's position and moving forward and leftward. Simultaneously activating a fourth sensor with an activated first sensor controls an object in a nineteenth state, preferably reducing an object's position and moving forward and rightward. Deactivating a third sensor continues control of an object in a seventeenth state. Deactivating a first sensor exits control of an object in a seventeenth state and continues control of an object in a fourteenth state. Simultaneously activating and deactivating a third sensor and a fourth sensor stops control of an object in a fourteenth state.

In another preferred embodiment, combinations of four sensors control an object, enabling movement for robots, toys, video games, etc. Simultaneously activating and deactivating a third sensor, preferably a left sensor, and a fourth sensor, preferably a right sensor, controls an object in a fourteenth state, preferably reducing an object's position. Activating a second sensor, preferably a down sensor, controls an object in an twentieth state, preferably reducing an object's position and moving backward. Simultaneously activating a third sensor with an activated second sensor controls an object in a twenty-first state, preferably reducing an object's position and moving backward and leftward. Deactivating a third sensor continues control of an object in a twentieth state. Simultaneously activating a fourth sensor with an activated second sensor controls an object in a twenty-second state, preferably reducing an object's position and moving backward and rightward. Deactivating a fourth sensor continues control of an object in a twentieth state. Deactivating a second sensor exits control of an object in a twentieth state and continues control of an object in a fourteenth state. Simultaneously activating and deactivating a third sensor and a fourth sensor stops control of an object in a fourteenth state.

In another preferred embodiment, combinations of four sensors control an object, enabling movement for robots, toys, video games, etc. Simultaneously activating and deactivating a third sensor, preferably a left sensor, a second sensor, preferably a down sensor, and a fourth sensor, preferably a right sensor, controls an object in a twenty-third state, preferably reducing an object to its lowest position. Simultaneously activating and deactivating a third sensor, a first sensor, preferably an up sensor, and a fourth sensor exits control of an object in a twenty-third state.

In another preferred embodiment, combinations of four sensors control an object, enabling movement for robots, toys, video games, etc. Simultaneously activating and deactivating a third sensor, preferably a left sensor, a second sensor, preferably a down sensor, and a fourth sensor, preferably a right sensor, controls an object in a twenty-third state, preferably reducing an object to its lowest position. Activating a third sensor, preferably an up sensor, controls an object in a twenty-fourth state, preferably reducing an object to its lowest position and moving leftward. Activating a fourth sensor, preferably an up sensor, controls an object in a twenty-fifth state, preferably reducing an object to its lowest position and moving rightward. Activating a first sensor, preferably an up sensor, controls an object in a twenty-sixth state, preferably reducing an object to its lowest position and moving forward. Simultaneously activating a third sensor with an activated first sensor controls an object in an twenty-seventh state, preferably reducing an object to its lowest position and moving forward and leftward. Deactivating a third sensor continues control of an object in a twenty-sixth state. Simultaneously activating a fourth sensor with an activated first sensor controls an object in a twenty-eighth state, preferably reducing an object to its lowest position and moving forward and rightward. Deactivating a fourth sensor continues control of an object in a twenty-sixth state. Deactivating a first sensor exits control of an object in a twenty-sixth state and continues control of an object in a twenty-third state. Simultaneously activating and deactivating a third sensor, a second sensor and a fourth sensor stops control of an object in a twenty-third state.

In another preferred embodiment, combinations of four sensors control an object, enabling movement for robots, toys, video games, etc. Simultaneously activating and deactivating a third sensor, preferably a left sensor, a second sensor, preferably a down sensor, and a fourth sensor, preferably a right sensor, controls an object in a twenty-third state, preferably reducing an object to its lowest position. Activating a second sensor controls an object in an twenty-ninth state, preferably reducing an object to its lowest position and moving backward. Simultaneously activating a third sensor with an activated second sensor controls an object in a thirtieth state, preferably reducing an object to its lowest position and moving backward and leftward. Deactivating a third sensor continues control of an object in a twenty-ninth state. Simultaneously activating a fourth sensor with an activated second sensor controls an object in a thirty-first state, preferably reducing an object to its lowest position and moving backward and rightward. Deactivating a fourth sensor continues control of an object in a twenty-ninth state. Deactivating a second sensor exits control of an object in a twenty-ninth state and continues control of an object in a twenty-third state. Simultaneously activating and deactivating a third sensor, a second sensor and a fourth sensor stops control of an object in a twenty-third state.

In another preferred embodiment, combinations of four sensors control an object, enabling movement for robots, toys, video games, etc. Simultaneously activating a third sensor, preferably a left sensor, a first sensor, preferably an up sensor, and a second sensor, preferably a down sensor, controls an object in a thirty-second state, preferably rotating an object counter-clockwise. Simultaneously deactivating a third sensor, a first sensor and a second sensor stops control of an object in a thirty-second state. Simultaneously activating a fourth sensor, preferably a right sensor, a first sensor and a second sensor controls an object in a thirty-third state, preferably rotating an object clockwise. Simultaneously deactivating a fourth sensor, a first sensor and a second sensor stops control of an object in a thirty-third state.

In another preferred embodiment, combinations of four sensors control an object, enabling movement for robots, toys, video games, etc. Simultaneously activating a first sensor, preferably an up sensor, and a third sensor, preferably a left sensor, controls an object in a thirty-fourth state. Deactivating a first sensor and a third sensor stops control of an object in a thirty-fourth state, preferably climbing and rolling an object leftward. Simultaneously activating a first sensor and a fourth sensor, preferably a right sensor, controls an object in a thirty-fifth state. Deactivating a first sensor and a fourth sensor stops control of an object in a thirty-fifth state, preferably climbing and rolling an object rightward.

In another preferred embodiment, combinations of four sensors control an object, enabling movement for robots, toys, video games, etc. Simultaneously activating a second sensor, preferably a down sensor, and a third sensor, preferably a left sensor, controls an object in a thirty-sixth state. Deactivating a second sensor and a third sensor stops control of an object in a thirty-sixth state, preferably diving and rolling an object leftward. Simultaneously activating a second sensor and a fourth sensor, preferably a right sensor, controls an object in a thirty-seventh state. Deactivating a second sensor and a fourth sensor stops control of an object in a thirty-seventh state, preferably diving and rolling an object rightward.

In another preferred embodiment, combinations of four sensors control an object, enabling movement for robots, toys, video games, etc. Simultaneously activating a first sensor, preferably an up sensor, and a second sensor, preferably a down sensor, controls an object in a thirty-eighth state, preferably changing modes of an object.

In another preferred embodiment, combinations of four sensors control an object, enabling movement for robots, toys, video games, etc. Simultaneously activating a third sensor, preferably a left sensor, and a fourth sensor, preferably a right sensor, exits a chordic four sensor first mode, and enters a chordic four sensor second mode, wherein activating combinations of the same four sensors produces secondary control functions. Simultaneously activating a third sensor and a fourth sensor exits the chordic four sensor second mode and re-enters the chordic four sensor first mode.

In another preferred embodiment, combinations of four sensors control an object, enabling movement for robots, toys, video games, etc. Simultaneously activating a third sensor, preferably a left sensor, a second sensor, preferably a down sensor, and a fourth sensor, preferably a right sensor, exits a chordic four sensor first mode, and enters a chordic four sensor second mode, wherein activating combinations of the same four sensors produces secondary control functions. Simultaneously activating a third sensor, a second sensor and a fourth sensor exits the chordic four sensor second mode and re-enters the chordic four sensor first mode.

In another preferred embodiment, combinations of four sensors control an object, enabling movement for robots, toys, video games, etc. Simultaneously activating a first sensor, preferably an up sensor, and a second sensor, preferably a down sensor, exits a chordic four sensor first mode, and enters a chordic four sensor second mode, wherein activating combinations of the same four sensors produces secondary control functions. Simultaneously activating a first sensor and a second sensor exits the chordic four sensor second mode and re-enters the chordic four sensor first mode.

In other preferred embodiments of the present invention, simultaneously activating two sensors, three sensors or four sensors exits a chordic four sensor first mode, and enters a chordic four sensor second mode, wherein activating combinations of the same four sensors produces secondary control functions. Simultaneously activating the same two sensors, three sensors or four sensors exits the chordic four sensor second mode and re-enters the chordic four sensor first mode.

Another preferred embodiment of the present invention allows multiple methods of control using only four sensors. Independently activating a first sensor, preferably a cursor left sensor, controls an object in a first state, preferably moving an object to the left, and deactivating a first sensor stops control in a first state, stopping leftward movement. Independently activating a second sensor, preferably a cursor right sensor, controls an object in a second state, preferably moving an object to the right, and deactivating a second sensor stops control in a second state, stopping rightward movement. Simultaneously activating a first sensor and a second sensor, followed by simultaneously deactivating a first sensor and a second sensor exits a first mode, preferably a first cursor movement mode, and enters a second mode, preferably a first editing mode. Independently activating a first sensor controls an object in a third state, preferably backspacing, and deactivating a first sensor stops control in a third state, stopping backspacing. Independently activating a second sensor controls an object in a fourth state, preferably deleting data, and deactivating a second sensor stops control in a fourth state, stopping the deletion of data. Simultaneously activating a first sensor and a second sensor, followed by simultaneously deactivating a first sensor and a second sensor or activating a fifth sensor exits a second mode, preferably a first editing mode, and re-enters a preferable first mode, preferably a first cursor movement mode or another preferred mode.

Independently activating a third sensor, preferably an cursor up sensor, controls an object in a fifth state, preferably moving an object upward, and deactivating a third sensor stops control in a fifth state, stopping upward movement. Independently activating a fourth sensor, preferably a cursor down sensor, controls an object in a sixth state, preferably moving an object downward, and deactivating a fourth sensor stops control in a sixth state, stopping downward movement. Simultaneously activating a third sensor and a fourth sensor, followed by simultaneously deactivating a third sensor and a fourth sensor exits a third mode, preferably a second cursor movement mode, and enters a fourth mode, preferably a second editing mode. Independently activating a third sensor controls an object in a seventh state, preferably reversing the last undo, and deactivating a third sensor stops control in a seventh state, stopping the reversing of the last undo. Independently activating a fourth sensor controls an object in a eighth state, preferably reversing the last change, and deactivating a fourth sensor stops control in a eighth state, stopping the reversing of the last change. Simultaneously activating a third sensor and a fourth sensor, followed by simultaneously deactivating a third sensor and a fourth sensor or activating a fifth sensor exits a fourth mode, preferably a second editing mode, and re-enters a preferable third mode, preferably a second cursor movement mode or another preferred mode.

In the preferred embodiment of the present invention, when using a computer keyboard or other type of electronic data entry device, activating a sensor or a key produces an active output or a down scan code and deactivating the same sensor or key produces an inactive/null output or an up scan code. Programming an operating system to recognize the active output or down scan codes and the inactive/null output or up scan codes, enables any operating system to make full use of the present invention found in this patent application.

The presently disclosed four sensor control technology can be used for movement and control on, but not limited to: accelerometers, biometric sensors, biosensors, flex sensors, micro force sensors, motion sensors, movement sensors, optical sensors, piezoelectric force sensors, position sensors, pressure sensors, temperature sensors, touch sensors, touch screen sensors, contact switches, detector switches, dimmer switches, dual motion switches, electromechanical switches, key switches, membrane switches, pushbutton switches, rocker switches, rotary switches, toggle switches, etc.

The preferred embodiment of the invention uses the preferred cursor left sensor, the preferred cursor right sensor, the preferred cursor up sensor and the preferred cursor down sensor. Other preferred embodiments can use any four sensors a users assigns for control on a computer keyboard or other type of electronic data entry device. The preferred embodiment on a phone keypad uses the star/asterisk [*] key as the preferred left sensor, the pound/number sign [#] key as the preferred right sensor, the eight [8] key as the preferred up sensor and the zero [0] key as the preferred down sensor.

These and other features of the present invention will be more fully understood by referencing the drawings.

In summary, the four sensor control invention, according to the preferred embodiment and alternative preferred embodiments of the invention, is logically developed, relatively easy to learn and very quick to use.

While the invention has been described with reference to the preferred embodiment thereof, it will be appreciated by those of ordinary skill in the art that various modifications can be made to the system and method of the invention without departing from the spirit and scope of the invention as a whole.

1. A method of using four sensors to control an object comprising the steps of:
a) activating said four sensors individually to control said object in four states of control; and
b) simultaneously activating combinations of said four sensors to control said object in more than four states of control; and
c) activating one of said four sensors individually followed by activating combinations of said four sensors to control said object in more than four states of control.

2. A method of using four sensors to control an object comprising the steps of:
a) activating said four sensors individually to move said object in four different directions; and
b) simultaneously activating combinations of said four sensors to move said object in more than four different directions; and
c) activating one of said four sensors individually followed by activating combinations of said four sensors to move said object in more than four different directions.

3. A method of using four sensors to control an object comprising the steps of:
a) activating a first sensor of said four sensors controls said object in a first state, and deactivating said first sensor stops said control of said object in said first state; and
b) activating a second sensor of said four sensors controls said object in a second state, and deactivating said second sensor stops said control of said object in said second state; and
c) activating a third sensor of said four sensors controls said object in a third state, and deactivating said third sensor stops said control of said object in said third state; and
d) activating a fourth sensor of said four sensors controls said object in a fourth state, and deactivating said fourth sensor stops said control of said object in said fourth state; and
e) activating said first sensor controls said object in said first state, followed by simultaneously activating said third sensor with said activated first sensor controls said object in a fifth state, and deactivating said third sensor continues said control of said object in said first state, and deactivating said first sensor stops said control of said object in said first state; and
f) activating said first sensor controls said object in said first state, followed by simultaneously activating said fourth sensor with said activated first sensor controls said object in a sixth state, and deactivating said fourth sensor continues said control of said object in said first state, and deactivating said first sensor stops said control of said object in said first state; and
g) activating said second sensor controls said object in said second state, followed by simultaneously activating said third sensor with said activated second sensor controls said object in a seventh state, and deactivating said third sensor continues said control of said object in said second state, and deactivating said second sensor stops said control of said object in said second state; and
h) activating said second sensor controls said object in said second state, followed by simultaneously activating said fourth sensor with said activated second sensor controls said object in an eighth state, and deactivating said fourth sensor continues said control of said object in said second state, and deactivating said second sensor stops said control of said object in said second state.

4. A method of using four sensors to control an object, in accordance with claim 1, further comprising the steps of:
a) activating a first sensor of said four sensors controls said object in a first state, and deactivating said first sensor stops said control of said object in said first state; and
b) activating a second sensor of said four sensors controls said object in a second state, and deactivating said second sensor stops said control of said object in said second state; and
c) activating a third sensor of said four sensors controls said object in a third state, and deactivating said third sensor stops said control of said object in said third state; and
d) activating a fourth sensor of said four sensors controls said object in a fourth state, and deactivating said fourth sensor stops said control of said object in said fourth state.

5. A method of using four sensors to control an object, in accordance with claim 1, further comprising the steps of:
a) activating said first sensor controls said object in said first state, followed by simultaneously activating said third sensor with said activated first sensor controls said object in a fifth state, and deactivating said third sensor continues said control of said object in said first state, and deactivating said first sensor stops said control of said object in said first state; and
b) activating said first sensor controls said object in said first state, followed by simultaneously activating said fourth sensor with said activated first sensor controls said object in a sixth state, and deactivating said fourth sensor continues said control of said object in said first state, and deactivating said first sensor stops said control of said object in said first state; and
c) activating said second sensor controls said object in said second state, followed by simultaneously activating said third sensor with said activated second sensor controls said object in a seventh state, and deactivating said third sensor continues said control of said object in said second state, and deactivating said second sensor stops said control of said object in said second state; and
d) activating said second sensor controls said object in said second state, followed by simultaneously activating said fourth sensor with said activated second sensor controls said object in an eighth state, and deactivating said fourth sensor continues said control of said object in said second state, and deactivating said second sensor stops said control of said object in said second state.

6. A method of using four sensors to control an object, in accordance with claim 1, further comprising the steps of:
a) activating said first sensor controls said object in said first state;
b) followed by simultaneously activating said second sensor with said activated first sensor controls said object in a ninth state;
c) followed by deactivating said second sensor to stop said control of said object in said ninth state and continue said control of said object in said first state;
d) followed by deactivating said first sensor to stop control of said object in said first state.

7. A method of using four sensors to control an object, in accordance with claim 1, further comprising the steps of:
a) activating said first sensor controls said object in said first state;
b) followed by simultaneously activating said second sensor with said activated first sensor controls said object in a ninth state;
c) followed by simultaneously activating said third sensor with said activated first sensor and said activated second sensor controls said object in a tenth state;
d) followed by deactivating said third sensor to stop said control of said object in said tenth state and continue said control of said object in said ninth state;
e) followed by simultaneously activating said fourth sensor with said activated first sensor and said activated second sensor controls said object in an eleventh state;
f) followed by deactivating said fourth sensor to stop said control of said object in said eleventh state and continue said control of said object in said ninth state;
g) followed by deactivating said second sensor to stop said control of said object in said ninth state and continue said control of said object in said first state;
h) followed by deactivating said first sensor to stop control of said object in said first state.

8. A method of using four sensors to control an object, in accordance with claim 1, further comprising the steps of:
a) activating said first sensor controls said object in said first state;
b) followed by simultaneously activating said third sensor and said fourth sensor with said activated first sensor controls said object in a twelfth state;
c) followed by simultaneously deactivating said third sensor and said fourth sensor continues said control of said object in said first state;
d) followed by deactivating said first sensor stops said control of said object in said first state.

9. A method of using four sensors to control an object, in accordance with claim 1, further comprising the steps of:
a) activating said first sensor controls said object in said first state;
b) followed by simultaneously activating said third sensor, said second sensor and said fourth sensor with said activated first sensor controls said object in a thirteenth state;
c) followed by simultaneously deactivating said third sensor, said second sensor and said fourth sensor continues said control of said object in said first state;
d) followed by deactivating said first sensor stops said control of said object in said first state.

10. A method of using four sensors to control an object, in accordance with claim 1, further comprising the steps of:
a) simultaneously activating and deactivating said third sensor and said fourth sensor controls said object in a fourteenth state; and
b) simultaneously activating and deactivating said third sensor and said fourth sensor exits said control of said object in said fourteenth state.

11. A method of using four sensors to control an object, in accordance with claim 1, further comprising the steps of:
a) simultaneously activating and deactivating said third sensor and said fourth sensor controls said object in a fourteenth state; and
b) activating said third sensor controls said object in a fifteenth state, and deactivating said third sensor continues said control of said object in said fourteenth state; and
c) activating said fourth sensor controls said object in a sixteenth state, and deactivating said fourth sensor continues said control of said object in said fourteenth state; and
d) activating said first sensor controls said object in a seventeenth state;
e) followed by simultaneously activating said third sensor with said activated first sensor controls said object in an eighteenth state, and deactivating said third sensor continues said control of said object in said seventeenth state; and
f) followed by simultaneously activating said fourth sensor with said activated first sensor controls said object in a nineteenth state, and deactivating said fourth sensor continues said control of said object in said seventeenth state; and
g) deactivating said first sensor exits said control of said object in said seventeenth state and continues said control of said object in said fourteenth state; and
h) simultaneously activating and deactivating said third sensor and said fourth sensor stops said control of said object in said fourteenth state.

12. A method of using four sensors to control an object, in accordance with claim 1, further comprising the steps of:
a) simultaneously activating and deactivating said third sensor and said fourth sensor controls said object in a fourteenth state; and
b) activating said second sensor controls said object in an twentieth state;
c) followed by simultaneously activating said third sensor with said activated second sensor controls said object in a twenty-first state, and deactivating said third sensor continues said control of said object in said twentieth state; and
d) followed by simultaneously activating said fourth sensor with said activated second sensor controls said object in a twenty-second state, and deactivating said fourth sensor continues said control of said object in said twentieth state; and
e) deactivating said second sensor exits said control of said object in said twentieth state and continues said control of said object in said fourteenth state; and
f) simultaneously activating and deactivating said third sensor and said fourth sensor stops said control of said object in said fourteenth state.

13. A method of using four sensors to control an object, in accordance with claim 1, further comprising the steps of:
a) simultaneously activating and deactivating said third sensor, said second sensor and said fourth sensor controls said object in a twenty-third state; and
b) simultaneously activating and deactivating said third sensor, said second sensor and said fourth sensor exits said control of said object in said twenty-third state.

14. A method of using four sensors to control an object, in accordance with claim 1, further comprising the steps of:
a) simultaneously activating and deactivating said third sensor, said second sensor and said fourth sensor controls said object in a twenty-third state; and
b) activating said third sensor controls said object in a twenty-fourth state, and deactivating said third sensor continues said control of said object in said twenty-third state; and
c) activating said fourth sensor controls said object in a twenty-fifth state, and deactivating said fourth sensor continues said control of said object in said twenty-third state; and
d) activating said first sensor controls said object in a twenty-sixth state;
e) followed by simultaneously activating said third sensor with said activated first sensor controls said object in an twenty-seventh state, and deactivating said third sensor continues said control of said object in said twenty-third state; and
f) followed by simultaneously activating said fourth sensor with said activated first sensor controls said object in a twenty-eighth state, and deactivating said fourth sensor continues said control of said object in said twenty-third state; and
g) deactivating said first sensor exits said control of said object in said twenty-sixth state and continues said control of said object in said twenty-third state; and
h) simultaneously activating and deactivating said third sensor, said second sensor and said fourth sensor stops said control of said object in said twenty-third state.

15. A method of using four sensors to control an object, in accordance with claim 1, further comprising the steps of:
a) simultaneously activating and deactivating said third sensor, said second sensor and said fourth sensor controls said object in a twenty-third state; and
b) activating said second sensor controls said object in an twenty-ninth state;
c) followed by simultaneously activating said third sensor with said activated second sensor controls said object in a thirtieth state, and deactivating said third sensor continues said control of said object in said twenty-ninth state; and
d) followed by simultaneously activating said fourth sensor with said activated second sensor controls said object in a thirty-first state, and deactivating said fourth sensor continues said control of said object in said twenty-ninth state; and
e) deactivating said second sensor exits said control of said object in said twenty-ninth state and continues said control of said object in said twenty-third state; and
f) simultaneously activating and deactivating said third sensor, said second sensor and said fourth sensor stops said control of said object in said twenty-third state.

16. A method of using four sensors to control an object, in accordance with claim 1, further comprising the steps of:
a) simultaneously activating said third sensor, said first sensor and said second sensor controls said object in a thirty-second state;
b) followed by simultaneously deactivating said third sensor, said first sensor and said second sensor stops said control of said object in said thirty-second state; and
c) simultaneously activating said fourth sensor, said first sensor and said second sensor controls said object in a thirty-third state;
d) followed by simultaneously deactivating said fourth sensor, said first sensor and said second sensor stops said control of said object in said thirty-third state.

17. A method of using four sensors to control an object, in accordance with claim 1, further comprising the steps of:
a) simultaneously activating said first sensor and said third sensor controls said object in a thirty-fourth state, and deactivating said first sensor and said third sensor stops control of said object in said thirty-fourth state; and
a) simultaneously activating said first sensor and said fourth sensor controls said object in a thirty-fifth state, and deactivating said first sensor and said fourth sensor stops control of said object in said thirty-fifth state.

18. A method of using four sensors to control an object, in accordance with claim 1, further comprising the steps of:
a) simultaneously activating said second sensor and said third sensor controls said object in a thirty-sixth state, and deactivating said second sensor and said third sensor stops control of said object in said thirty-sixth state; and
b) simultaneously activating said second sensor and said fourth sensor controls said object in a thirty-seventh state, and deactivating said second sensor and said fourth sensor stops control of said object in said thirty-seventh state.

19. A method of using four sensors to control an object, in accordance with claim 1, further comprising the step of:
a) simultaneously activating said first sensor and said second sensor controls said object in a thirty-eighth state.

20. A method of using four sensors controls an object, in accordance with claim 1, further comprising the steps of:
a) simultaneously activating two sensors of said four sensors exits a first mode and enters a second mode;
b) activating combinations of said four sensors produces second mode control; and
c) simultaneously activating said same two sensors of said four sensors exits said second mode and re-enters said first mode.

21. A method of using four sensors controls an object, in accordance with claim 1, further comprising the steps of:
a) simultaneously activating three sensors of said four sensors exits a first mode and enters a second mode;
b) activating combinations of said four sensors produces second mode control; and
c) simultaneously activating said same three sensors of said four sensors exits said second mode and re-enters said first mode.

22. A method of using four sensors controls an object, in accordance with claim 1, further comprising the steps of:
a) simultaneously activating said four sensors exits a first mode and enters a second mode;
b) activating combinations of said four sensors produces second mode control; and
c) simultaneously activating said four sensors exits said second mode and re-enters said first mode.
